(19) United States
(12) Patent Application Publication
(10) Pub. No.: US 2012/0103215 A1
(43) Pub. Date: May 3, 2012

(54) VARNISHING OR PRINTING PLATE

(76) Inventor: Arrio Vavassori Bisutti, Bergamo (IT)

(21) Appl. No.: 13/099,769

(22) Filed: May 3, 2011

(30) Foreign Application Priority Data
May 17, 2010 (EP) 10425160.8

(51) Int. Cl. B41N 1/16

(52) U.S. Cl. 101/401

(57) ABSTRACT

A varnishing or printing plate includes a support layer, a varnish or ink transfer layer and a filling layer interposed between the support layer and the varnish or ink transfer layer. The filling layer comprises a plurality of sublayers connected together in succession so as to form the filling layer made of a polyurethane. Each of said sublayers of the filling layer has a thickness between 160 and 330 micron, and the polyurethane with which said sublayers of the filling layer are made is such that they have a Shore A hardness of between 55° and 65°.

### FIELD OF THE INVENTION

The present invention relates to a varnishing or printing plate for the respective varnishing or printing phase (in substitution of a so-called “printing blanket” or “litho blanket”) in a printing process, in particular in a so-called “offset” printing process.

### BACKGROUND OF THE INVENTION

In these printing processes, a sheet to be printed, for example a packaging, is passed in sequence, using rollers, through successive stations, each one corresponding to a colour (typically: black, magenta, cyan, yellow and possibly an additional colour), in which inks of the above-mentioned colours are applied to the sheet to be printed to create the desired image.

In each printing station, the offset printing process takes place using rollers and cylinders. A first roller is daubed with ink and placed in contact with a cylinder covered with an aluminium plate on which the image to printed has been previously impressed. In turn, the aluminium plate is placed in contact with another cylinder covered with a so-called “printing blanket”, which is placed in contact with the sheet to be printed.

Downstream of the printing stations, the printed sheet is processed in a varnishing station, in which the printed surface is protected or finished with a suitable varnish. This varnish can be in the form of an aqueous solution or even an organic solvent solution, which can be hardened via UV radiation or heat.

In the varnishing station, there is a first cylinder (so-called anylox® cylinder) provided with special cells that retain the varnish, taken from a tank, and transfer it to a varnishing plate fitted on a second plate-carrier cylinder. The varnishing plate retains the varnish and transfers it to the surface of previously printed sheet. The transfer of varnish is performed by making the sheet pass between the second cylinder, on which the varnishing plate is fitted, and a third, counter-pressure cylinder.

A known varnishing plate comprises a support layer, a varnish transfer layer and a filling layer inserted between the varnish transfer layer and the support layer. The filling layer is made of PVC.

With particular reference to the plate's PVC filling layer, it has a quite sizeable thickness of approximately 800 micron or more, while the varnish transfer layer, normally made of a more precious material and therefore more expensive, has a significantly smaller thickness. As the filling layer is made using extrusion or calendering processes, given its significant thickness, it is normally subject to planarity defects (in other words, its thickness is not sufficiently uniform) and surface finish defects. This happens because of the mechanical stresses the polymer is subjected to during processing. These stresses increase with the thickness of the extruded material.

Due to the unevenness in the thickness of the filling layer, also the varnish applied via the varnishing plate is not adequately even and therefore not always satisfactory.

An additional drawback of the known plate is that PVC does not have suitable resilience characteristics. In its normal usage as a varnishing plate, the plate is subjected to compression between the anylox® cylinder and the plate-carrier cylinder and between the plate-carrier cylinder and the counter-pressure cylinder. Since the compression varies between one cycle and the next, or in the passage between areas of the sheet with different thicknesses, or in the passage between areas to varnish and areas not to varnish, the plate is not able to completely and almost immediately return to its original thickness, which can cause further defects in the quality of varnishing.

There are similar problems in cases where it is wished to use the above-described plate as an alternative to the printing blanket in printing processes.

The object of the present invention is therefore that of making available a plate that can be used in varnishing processes with increased varnishing performance (that is, such as to ensure increased varnishing quality), which can also be used, with high printing performance, in printing processes in substitution of a printing blanket.

### SUMMARY OF THE INVENTION

This and other objects are achieved by means of a varnishing or printing plate and a method for the manufacture of the varnishing or printing plate, as described below.

### BRIEF DESCRIPTION OF THE DRAWINGS

To better understand the invention and appreciate the advantages, some embodiments are described below by way of non-limitative examples, with reference to the enclosed figures, where:

FIG. 1 is a schematic cross-section view of a varnishing or printing plate in accordance with a first embodiment of the invention,

FIG. 2 is a schematic cross-section view of a varnishing or printing plate in accordance with a second embodiment of the invention,

FIG. 3 is a schematic cross-section view of a varnishing or printing plate in accordance with a third embodiment of the invention,

FIG. 4 is a schematic cross-section view of a varnishing or printing plate in accordance with a fourth embodiment of the invention, and

FIG. 5 is a schematic cross-section view of a varnishing or printing plate in accordance with a fifth embodiment of the invention.

### DETAILED DESCRIPTION OF THE INVENTION

With reference to the enclosed figures, a varnishing or printing plate is indicated by reference numeral 1. The plate 1 is suitable for being fitted on a suitable cylinder of a varnishing unit (not shown in the figures), for example downstream of an offset printing unit (such as the type previously described), for the final varnishing of a sheet printed in the stations of the printing unit.

The plate 1 is also suitable for being fitted on a cylinder in a printing unit (not shown in the figures), in substitution of the so-called “printing blanket”. In the printing unit, a roller daubed in ink transfers the ink to an aluminium plate on which the image to be printed has been impressed. The aluminium plate then selectively transfers the ink, according to the image to be printed, onto the plate 1, which is then placed in contact with the sheet to be printed.

The plate 1 according to the invention can therefore be alternatively exploited in the printing or varnishing processes.

The plate 1 comprises a support layer 2, a varnish (in the case where the plate 1 is used for the varnishing phase) or ink (in the case where the plate 1 is used for the printing phase) transfer layer 3 and a filling layer 4 inserted between the support layer 2 and the varnish or ink transfer layer 3.

The support layer 2 has the function of supporting the filling layer 4 and the varnish or ink transfer layer 3 and therefore has dimensional stability and mechanical resistance characteristics. This allows the plate 1 to be used repeatedly and therefore to repeat a number of varnishing or printing operations with the same plate. The support layer 2 preferably has a thickness between 250 and 400 micron, even more preferably between 320 and 380 micron, for example, approximately 350 micron. It can be made of, for example, bi-oriented polyester, in particular polyethylene terephthalate (PET), which allows the above mentioned mechanical properties to be achieved.

An auxiliary support layer 5 can optionally be associated with the support layer 2 to support the support layer 2 itself. The auxiliary support layer 5 has the function of increasing the overall thickness of the plate 1, which can then be used in substitution of known printing blankets on the same machine without the need to modify the sub-plate shimming (such printing blankets normally have a fixed thickness of 1.95 mm). The thickness of the auxiliary support layer 5 can therefore vary in function of the usage requirements of the varnishing plate 1.

The auxiliary support layer 5 can be made, for example, of non woven polyester fabric, preferably impregnated with rubber latex.

The varnish or ink transfer layer 3 has surface tension, roughness and granularity characteristics that allow the varnish or ink to be retained for subsequent release on the sheet to be varnished or printed.

Suitable materials with which the varnish or ink transfer layer 3 can be made are polyurethanes, epoxy resins modified with urethane groups, silicones, modified silicones or mixtures thereof. In addition, the varnish or ink transfer layer 3 can contain polyethers, aromatic polyethers or polyether polyols. In accordance with a preferred embodiment, the varnish or ink transfer layer 3 is made of polyester-based or polyether-based polyurethane.

As the materials of the varnish or ink transfer layer 3 generally have high costs, the varnish or ink transfer layer 3 preferably has a thickness less than the overall thickness of the filling layer 4. Preferably, the varnish or ink transfer layer 3 has a thickness between 60 and 300 micron, even more preferably between 130 and 170 micron, for example approximately 140, 150, or 160 micron.

Advantageously, the varnish or ink transfer layer 3 has a surface tension higher than that of the filling layer 4 and therefore has a greater capacity to retain the varnish or ink than the filling layer 4.

Advantageously, the filling layer 4 comprises a plurality of successive sublayers 4′, 4″, 4′″, 4″″ made of a thermoplastic elastomer, preferably a polyurethane.

Each of the sublayers 4′, 4″, 4′″, 4″″ has limited thickness, in particular a thickness between 50 and 400 micron, preferably between 160 and 330 micron. According to possible special embodiments, each of the sublayers 4′, 4″, 4′″, 4″″ has a thickness between 250 and 330 micron, for example approximately 280 or 325 micron. According to further possible particular embodiments, each of the sublayers 4′, 4″, 4′″, 4″″ has a thickness between 160 and 240 micron, for example approximately 210 or 220 micron.

With respect to materials of the known art, such as PVC, the use of a thermoplastic elastomer, in particular a polyurethane, for making the sublayers 4′, 4″, 4′″, 4″″ of the filling layer 4, guarantees superior varnishing or printing performance and quality. In fact, this material is generally not as hard as PVC and is more resilient. Therefore, it can be easily compressed and return to its original thickness. These physical characteristics can be exploited in the varnishing or printing process, during which the plate 1 is first compressed and then released.

In addition to this, the multilayer structure of the filling layer 4 ensures that each of the sublayers 4′, 4″, 4′″, 4″″ can be manufactured independently of the others and kept within limited thicknesses. The manufacturing is therefore simpler and allows planarity defects to be limited. As a whole, the resulting plate 1 therefore guarantees high varnishing or printing performances.

A further advantage of the structure of the plate 1 is that it is possible to easily separate the varnish transfer layer 3-filling layer 4 group from the support layer 2, so as to be able to recycle the two products of different composition separately, if necessary.

Preferably, the sublayers of the filling layer 4 are between 2 and 7 in number and, still more preferably, have thicknesses that are substantially the same.

Advantageously, the material with which the sublayers 4′, 4″, 4′″, 4″″ are made is such that the latter have a hardness between 55° and 65° Shore A, for example 58° Shore A. Polyester-based or polyether-based polyurethanes are suitable materials for this purpose.

The sublayers 4′, 4″, 4′″, 4″″ of the filling layer 4 can be connected to each other via thermal adhesives placed on their interfaces 6. Thermal adhesives have limited thickness (normally 10-20 micron), which obviously increases the overall thickness of the filling layer 4.

Alternatively, the sublayers 4′, 4″, 4′″, 4″″ can be connected together via a hot lamination process, which causes local melting of the sublayers 4′, 4″, 4′″, 4″″ and their consequent adhesion at the interfaces 6 following solidification. In this way, a filling layer 4 is obtained as a single body, starting from sublayers of limited thicknesses, which are more easily manufactured for the above-stated reasons.

Similarly, the connection between the support layer 2 and the filling layer 4, and between the varnish or ink transfer layer 3 and the filling layer 4 can also be achieved by means of hot lamination or suitable thermoadhesives.

The plate 1 according to the invention can be manufactured in accordance with a method, the phases of which shall now be described.

The method of making the plate 1 comprises a phase of preparing the sublayers 4′, 4″, 4′″, 4″″ of the filling layer 4. For example, these sublayers 4′, 4″, 4′″, 4″″ can be prepared by extrusion or calendering. The support layer 2 and the varnish or ink transfer layer 3 can also be prepared using similar techniques.

The so-prepared sublayers 4′, 4″, 4′″, 4″″ are connected together in a preparation phase of the filling layer 4. The connection of the sublayers 4′, 4″, 4′″, 4″″ can be effected by means of the previously mentioned thermoadhesives or by means of hot lamination.

The filling layer is then connected to the varnish or ink transfer layer 3 and to the support layer 2. Optionally, the support layer 2 can be connected to the auxiliary support layer 5, if provided. Alternatively, the stated connection operations can be achieved by means of by means of hot lamination or thermoadhesives.

With reference to the enclosed figures, some possible embodiments of the plate 1 according to the invention will be now described.

### First Embodiment

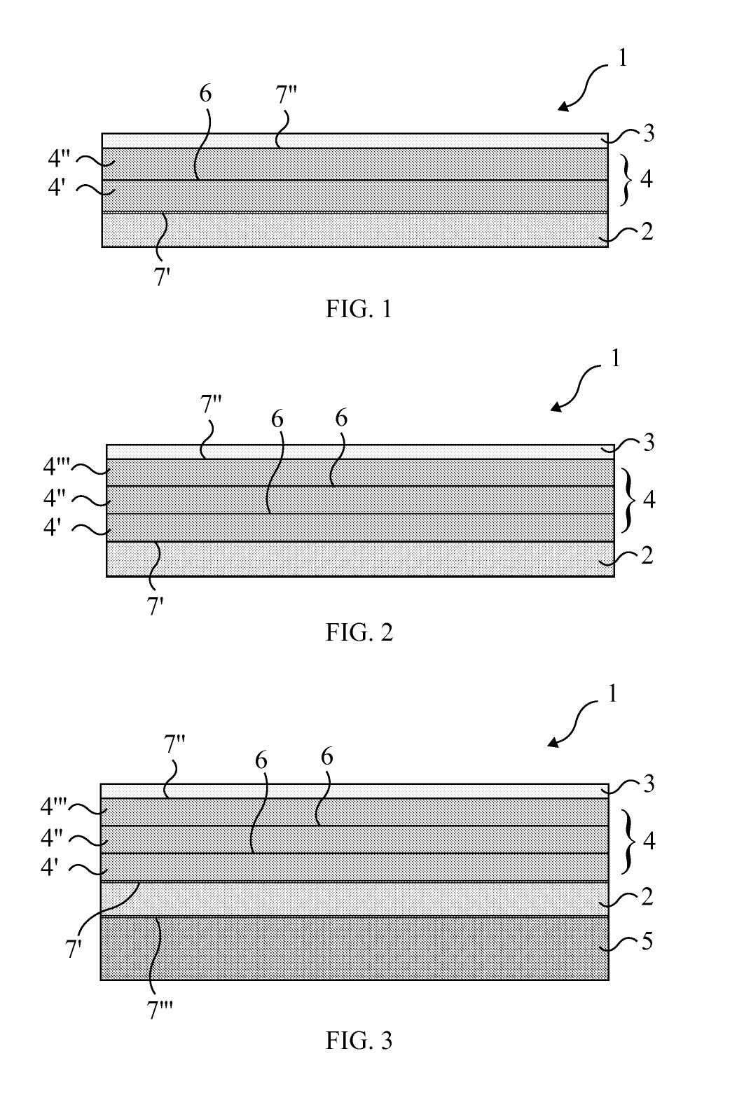

In accordance with a first embodiment, shown in FIG. 1, the plate 1 comprises a varnish or ink transfer layer 3 made of polyester-based polyurethane and having a thickness of approximately 150 micron.

The filling layer 4 is provided with two sublayers 4′ and 4″ having thicknesses of approximately 325 micron and made of polyester-based polyurethane with an approximate hardness of 58° Shore A.

The plate 1 further comprises a support layer 2 made of polyethylene terephthalate with a thickness of approximately 350 micron.

The sublayers 4′ and 4″ are bound together by hot lamination and are respectively bound to the support layer 2 and to the varnish or ink transfer layer 3 by thermoadhesives 7′ and 7″. The thermoadhesives 7′ and 7″ have thicknesses of approximately 20 micron.

The so-formed plate 1 has an overall hardness of approximately 82° Shore A.

### Second Embodiment

In accordance with a second embodiment, shown in FIG. 2, the plate 1 comprises a varnish or ink transfer layer 3 made of polyester-based polyurethane and having a thickness of approximately 150 micron.

The filling layer 4 is provided with three sublayers 4′, 4″ and 4′″ having thicknesses of approximately 280 micron and made of polyester-based polyurethane with an approximate hardness of 58° Shore A.

The plate 1 also comprises a support layer 2 made of polyethylene terephthalate and with a thickness of approximately 350 micron.

The sublayers 4′, 4″ and 4′″ are bound together by hot lamination. The sublayers 4′ and 4′″ at the ends of the filling layer 4 are respectively bound to the support layer 2 and to the varnish transfer layer 3 by thermoadhesives 7′ and 7″. The thermoadhesives 7′ and 7″ have thicknesses of approximately 20 micron.

The so-formed plate 1 has an overall hardness of approximately 81° Shore A.

### Third Embodiment

In accordance with a third embodiment, shown in FIG. 3, the plate 1 comprises a varnish or ink transfer layer 3 made of polyester-based polyurethane and having a thickness of approximately 150 micron.

The filling layer 4 is provided with three sublayers 4′, 4″ and 4′″ having thicknesses of approximately 280 micron and made of polyester-based polyurethane with an approximate hardness of 58° Shore A.

The plate 1 further comprises a support layer 4 made of polyethylene terephthalate and with a thickness of approximately 350 micron.

The sublayers 4′, 4″ and 4′″ are bound together by hot lamination. The sublayers 4′ and 4′″ at the ends of the filling layer 4 are respectively bound to the support layer 2 and to the varnish or ink transfer layer 3 by thermoadhesives 7′ and 7″. The thermoadhesives have thicknesses of approximately 20 micron.

An auxiliary support layer 5 made of a non woven fabric impregnated with rubber latex and having a thickness of approximately 650 micron is connected to the support layer 2 by a thermoadhesive 7′″.

The so-formed plate 1 has an overall hardness of approximately 80° Shore A.

### Fourth Embodiment

In accordance with a fourth embodiment, shown in FIG. 4, the plate 1 comprises a varnish or ink transfer layer 3 made of polyester-based polyurethane and having a thickness of approximately 140 micron.

The filling layer 4 is provided with three sublayers 4′, 4″ and 4′″ having thicknesses of approximately 220 micron and made of polyester-based polyurethane.

The plate 1 also comprises a support layer 2 made of polyethylene terephthalate and with a thickness of approximately 350 micron.

The sublayers 4′, 4″ and 4′″ are bound together by hot lamination. The sublayers 4′ and 4′″ at the ends of the filling layer 4 are respectively bound to the support layer 2 and to the varnish or ink transfer layer 3 by means of hot lamination.

### Fifth Embodiment

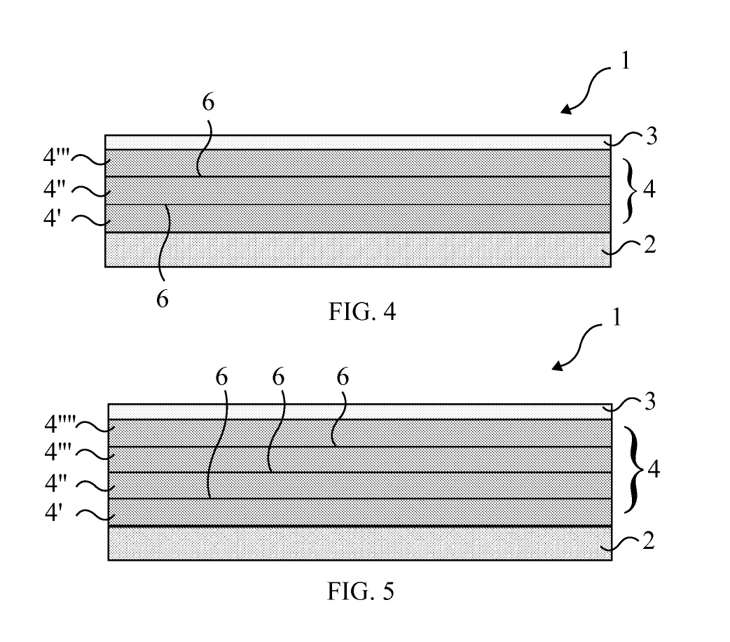

In accordance with a fifth embodiment, shown in FIG. 5, the plate 1 comprises a varnish or ink transfer layer 3 made of polyester-based polyurethane and having a thickness of approximately 160 micron.

The filling layer 4 is provided with four sublayers 4′, 4″, 4′″ and 4″″ having thicknesses of approximately 210 micron and made of polyester-based polyurethane.

The plate 1 also comprises a support layer 2 made of polyethylene terephthalate and with a thickness of approximately 350 micron.

The sublayers 4′, 4″, 4′″ and 4″″ are bound together by hot lamination. The sublayers 4′ and 4″″ at the ends of the filling layer 4 are respectively bound to the support layer 2 and to the varnish or ink transfer layer 3 by means of hot lamination.

From the description provided above, an expert in the field can appreciate how the plate according to the invention guarantees high varnishing or printing performance.

In fact, the filling layer formed as a multilayer structure with sublayers of limited thicknesses made of a thermoplastic elastomer ensures suitable mechanical properties as well as limited planarity defects.

In order to satisfy specific contingent requirements, an expert in the field could make numerous additions or modifications to the above-described embodiments or substitute elements with others of equivalent functionality, without however leaving the scope of the following claims.

What is claimed is:

1. Varnishing or printing plate comprising a support layer, a varnish or ink transfer layer and a filling layer interposed between said support layer and said varnish or ink transfer layer, wherein said filling layer comprises a plurality of sublayers, connected together in succession so as to form the filling layer, made of a polyurethane, wherein each of said sublayers of the filling layer has a thickness between 160 and 330 micron, wherein the polyurethane with which said sublayers of the filling layer are made is such that they have a hardness of between 55° and 65° Shore A.

2. Varnishing or printing plate according to the claim 1, in which said polyurethane with which the sublayers of the filling layer are made is a polyester-based or polyether-based polyurethane.

3. Varnishing or printing plate according to claim 1, in which said sublayers of the filling layer have substantially the same thicknesses.

4. Varnishing or printing plate according to claim 1, in which said sublayers of the filling layer are between 2 and 7 in number.

5. Varnishing or printing plate according to claim 1, in which said sublayers of the filling layer are connected together by means of hot lamination or thermoadhesives.

6. Varnishing or printing plate according to claim 1, in which said filling layer is connected to said varnish or ink transfer layer and to said support layer by means of hot lamination or thermoadhesives.

7. Varnishing or printing plate according to claim 1, in which said varnish or ink transfer layer has a thickness between 60 and 300 micron.

8. Varnishing or printing plate according to claim 1, in which said varnish or ink transfer layer is made of a polyester-based or polyether-based polyurethane.

9. Varnishing or printing plate according to claim 1, in which said support layer is made of bi-oriented polyester, in particular polyethylene terephthalate.

10. Varnishing or printing plate according to claim 1, in which said support layer has a thickness between 250 and 400 micron.

11. Varnishing or printing plate according to claim 1, further comprising an auxiliary support layer that supports said support layer.

12. Varnishing or printing plate according to claim 11, in which said auxiliary support layer is made of a non woven polyester fabric, in particular one impregnated with rubber latex.

13. Method for the manufacture of a varnishing or printing plate comprising a support layer, a varnish or ink transfer layer and a filling layer interposed between said support layer and said varnish or ink transfer layer, wherein said filling layer comprises a plurality of sublayers connected together in succession so as to form the filling layer made of a polyurethane, wherein each of said sublayers of the filling layer has a thickness between 160 and 330 micron, wherein the polyurethane with which said sublayers of the filling layer are made is such that they have a hardness of between 55° and 65° Shore A, said method comprising the steps of:
preparing said plurality of sublayers of the filling layer;
connecting the sublayers of said plurality of sublayers together in succession so as to form the filling layer;
connecting the varnish or ink transfer layer to the filling layer;
connecting the filling layer to the support layer.
